(19) United States
(12) Patent Application Publication
(10) Pub. No.: US 2026/0283373 A1
(43) Pub. Date: Sep. 24, 2026

(54) SYSTEM AND A DEVICE FOR A REMOTE CONTROLLED FIRMNESS ADJUSTABLE AND MASSAGER MATTRESS

(71) Applicant: Ilham Oz, Pennsauken, NJ (US)

(72) Inventor: Ilham Oz, Pennsauken, NJ (US)

(21) Appl. No.: 19/082,392

(22) Filed: Mar. 18, 2025

(51) Int. Cl. A47C 27/18; A61H 9/00

(52) U.S. Cl. CPC A47C 27/18; A61H 9/0078; A61H 2201/0146; A61H 2201/5097

(57) ABSTRACT

A remote-controlled massager mattress is provided. The remote-controlled massager mattress includes a mattress having at least two layers of foam, a bottom layer, and a top layer. The bottom layer has a firm foam layer that consists of cylindrical holes through the width of the mattress. The holes have rubber cylindrical airbags that are inflated or deflated at different levels by a remote control via an air pump embedded inside the mattress.

### CROSS-REFERENCES TO RELATED APPLICATIONS

N/A.

### FIELD OF THE TECHNOLOGY

The present disclosure generally relates to massager mattress and, more specifically, to remote controlled firmness adjustable and massager mattress.

### DESCRIPTION OF THE RELATED ART

Historically, a mattress is a fabric case filled with a resilient material (such as cotton, hair, feathers, foam rubber, or an arrangement of coiled springs) used either alone as a bed or on a bedstead

In today's modern world, mattresses provide many functions for people like sleeping or resting or having sex, moreover also activities like working with computers, watching TV, reading books, having phone talk, making exercises, etc. on these mattresses.

What is needed is a system and a device having a remote-controlled firmness adjustable and massager mattress.

### SUMMARY

In an embodiment, a system includes a remote-controlled massager mattress. The remote-controlled massager mattress includes a mattress having at least two layers of foam, a bottom layer, and a top layer. The bottom layer has a firm foam layer that consists of cylindrical holes through the width of the mattress. The holes have rubber cylindrical airbags that are inflated or deflated at different levels by a remote control via an air pump embedded inside the mattress.

In another embodiment, a device includes a remote-controlled massager mattress. The remote-controlled massager mattress includes a mattress having at least two layers of foam, a bottom layer, and a top layer. The bottom layer has a firm foam layer that consists of cylindrical holes through the width of the mattress. The holes have rubber cylindrical airbags that are inflated or deflated at different levels by a remote control via an air pump embedded inside the mattress.

In still another embodiment, a remote-controlled massager mattress is provided. The remote-controlled massager mattress includes a mattress having at least two layers of foam, a bottom layer, and a top layer. The bottom layer has a firm foam layer that consists of cylindrical holes through the width of the mattress. The holes have rubber cylindrical airbags that are inflated or deflated at different levels by a remote control via an air pump embedded inside the mattress.

### BRIEF DESCRIPTION OF THE DRAWINGS

The present invention is described in detail below with reference to the attached drawing figures, which are incorporated by reference herein and wherein:

FIG. 1 illustrates an exemplary embodiment of the invention;

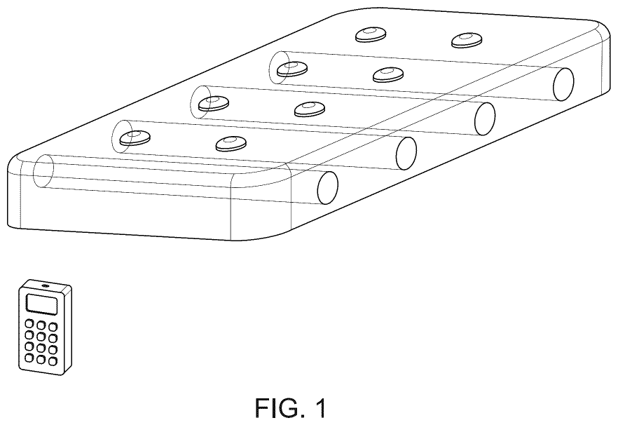

### DETAILED DESCRIPTIONS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent application, which would still fall within the scope of the claims.

It should also be understood that, unless a term is expressly defined in this patent using the sentence, there is no intent to limit the meaning of that term, either expressly or by implication, beyond its plain or ordinary meaning, and such term should not be interpreted to be limited in scope based on any statement made in any section of this patent application (other than the language of the claims). To the extent that any term recited in the claims at the end of this patent application is referred to in this patent application in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

In an embodiment, the present invention includes a mattress having at least two layers of foam, bottom layers, and top layers. The bottom layer is a firm foam that consists of cylindrical holes through the width of the mattress. In these holes, there are rubber cylindrical airbags that can be inflated or deflated at different levels by the user's remote control via an air pump embedded inside the mattress. The top layer is a softer foam that consists of hemispherical holes embedded on the surface of the layer. In these holes, there are massager elements that can be controlled by the same remote control. With this remote control, the user can not only adjust the level of firmness-softness and massage her-his body and/or body parts at customized intensity levels. Moreover, for double mattresses, there will be 2 different remote controls to be used separately for partners. The remote control can be wired or wireless.

In some embodiments, the bottom layer with embedded airbags that provide firmness levels with deflating-inflating air inside of them by remote control with levels via the help of an air pump embedded inside the mattress. These air pressure differences cause the mattress to be hard or soft or medium levels and their combinations are scaled from 1 to 10 on remote controls. The top layer which consists of massager elements embedded on the surface of the layer provides a massage function at different parts of the body at different intensity levels. As such, all turns out to be a mattress with both firmness adjustable and massager functions and that can be used separately and customized by partners on the same mattress. Further, double mattresses have 2 separate air pumps with 2 separate remote controls.

In alternate embodiments, the present invention includes an air pump embedded in the mattress that functions to inflate and deflate the airbags, embedded electrical wires from the air pump to the remote control (if wired), embedded massager elements, and their embedded wires from each element to the remote control, remote control main unit, foam layers with hole cuts according to airbags and massager elements' placements and a mattress cover that covers this inner layers to form a finished and sellable product.

In still another embodiment, the present invention may include mattresses' being soft or hard. Further, users might need and feel comfort according to their body types-sleeping habits at different firmness levels. Moreover, during many useful functions of mattresses, comfort levels come from different levels of firmness. For example, watching TV on a mattress might need a firmer level, on the other side reading a book on the mattress might need a softer level, etc., according to the anatomic and comfortable body needs of the user. On the other side, hard-working daily life forces the human body to have a massage to recover physically and mentally. This mattress solves this problem 1-by providing different levels of firmness and 2-also massaging according to different parts of the body.

In another embodiment, the present invention includes foundation for a bed system can include a foundation structure having a head, a foot, a first side, and a second side. An air pump configured for supplying air to and inflating at least one mattress air chamber can be housed within the foundation structure proximate the foot of the foundation structure. A control box and a central power hub can be housed within the foundation structure. The central power hub can be electrically connected to and configured to deliver electrical power to each of the air pump, the control box, and one or more additional electrical components. The foundation can optionally integrate other components into the foundation.

In still another embodiment, the present invention includes system can include a bed having a mattress, a sensor, and the data processing device. The sensor is configured to sense a feature of the mattress and transmit readings to a data processing device. The data processing device includes a processor and is configured to receive the readings from the sensor and determine if the readings i) indicate a user presence on the mattress and ii) indicate the user intends to sleep. The data processing device is configured to transmit a command to a peripheral controller responsive to determining that the readings i) indicate user presence on the mattress and ii) indicate the user intends to sleep.

In yet another embodiment, the present invention includes a bed has a foundation for supporting an air mattress. The foundation has a plurality of pivotally connected transverse plates that are moved to bend the mattress to a desired contour and shape. Open top recesses in the foundation located below the plates accommodate bags have flexible walls. The bags are separately expandable and contractible to move the plates to selected elevated positions. The recesses hold the bags in lifting positions relative to the plates when the bags are inflated. The bags fit into the recesses when deflated to allow the plates to move to a horizontal position. The bed is equipped with a vibrator that is operable to vibrate the air mattress.

In still another embodiment, the present invention includes an air bed having a pump and a relief valve is operably connected with a control box. The control box is capable of being programmed or receiving scripted information from a media file such that timed pressure changes may be made in the air bed by operation of the pump and the relief valve. These changes are synchronized with a message being played by a media player. Thus, the air bed interacts with a person lying on the bed. This interaction is used, preferably in a sales setting, to convey information to the person about the operation and features of the air bed.

Many different arrangements of the various components depicted, as well as components not shown, are possible without departing from the spirit and scope of the present invention. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

What is claimed is:

1. A system having a remote-controlled massager mattress comprising:
a mattress having at least two layers of foam, a bottom layer, and a top layer, wherein the bottom layer has a firm foam layer that consists of cylindrical holes through the width of the mattress; and wherein the holes have rubber cylindrical airbags that are inflated or deflated at different levels by a remote control via an air pump embedded inside the mattress.

2. The system of claim 1, wherein the air pump provides adjustable air pressure levels that lead to different firmness levels for the body of the user.

3. The system of claim 1, wherein the system includes a remote-controlled massager function that massages different parts of the body of the user.

4. The system of claim 1, wherein the system has the functionality to work with all types of filling materials that constitute a mattress not dependent on foam-type filling materials only.

5. The system of claim 1, wherein the air pump regulates air pressure differences to cause the mattress to be a hard level.

6. The system of claim 1, wherein the air pump regulates air pressure differences to cause the mattress to be a soft level.

7. The system of claim 1, wherein the air pump regulates air pressure differences to cause the mattress to be a medium level.

8. A device having a remote-controlled massager mattress comprising:
a mattress having at least two layers of foam, a bottom layer, and a top layer, wherein the bottom layer has a firm foam layer that consists of cylindrical holes through the width of the mattress; and wherein the holes have rubber cylindrical airbags that are inflated or deflated at different levels by a remote control via an air pump embedded inside the mattress.

9. The device of claim 8, wherein the air pump provides adjustable air pressure levels that lead to different firmness levels for the body of the user.

10. The device of claim 8, wherein the device includes a remote-controlled massager function that massages different parts of the body of the user.

11. The device of claim 8, wherein the device has the functionality to work with all types of filling materials that constitute a mattress not dependent on foam-type filling materials only.

12. The device of claim 8, wherein the air pump regulates air pressure differences to cause the mattress to be a hard level.

13. The device of claim 8, wherein the air pump regulates air pressure differences to cause the mattress to be a soft level.

14. The device of claim 8, wherein the air pump regulates air pressure differences to cause the mattress to be a medium level.
